(19) United States
(12) Patent Application Publication
(10) Pub. No.: US 2006/0137465 A1
(43) Pub. Date: Jun. 29, 2006

(54) Tri-axial bending load testing jig

(75) Inventors: Dong-woo Lee, Seoul (KR); Sin-taek Yim, Yangsan-si (KR); Seong-woon Booh, Yongin-si (KR); Jin-woo Cho, Seongnam-si (KR); Ki-taek Kim, Yongin-si (KR); Dong-ok Kwak, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/245,067

(22) Filed: Oct. 7, 2005

(30) Foreign Application Priority Data
Dec. 27, 2004 (KR) 2004-112701

(51) Int. Cl. G01N 3/00

(52) U.S. Cl. 73/794; 73/849

(57) ABSTRACT

A tri-axial bending load testing jig includes a die including first and second supporting axes which upholds opposite sides of a board material, the first and the second supporting axes movable so that an interval therebetween can be adjusted according to a size of the board material, a punch mounted at an upper part of the die movable in a vertical direction to press down a center portion of the board material, a punch setting unit formed in the center of the die to set the center and parallelism of the punch with respect to the first and the second supporting axes and having a punch groove for receiving the punch at the center portion of the die, and a material positioning unit guiding a position of the board material to be put on the first and the second supporting axes, according to the size of the board material.

### CROSS-REFERENCE TO RELATED APPLICATIONS

This application claims priority from Korean Patent Application No. 2004-112701, filed on Dec. 27, 2004 in the Korean Intellectual Property Office, the disclosure of which is incorporated herein by reference in its entirety.

### BACKGROUND OF THE INVENTION

1. Field of the Invention

The present invention relates to a jig used for a tri-axial bending load test to measure the strength of a board material. More particularly, the present invention relates to a tri-axial load testing jig especially applicable for materials of various sizes, for example, a small-sized liquid crystal display (LCD) for a mobile phone.

2. Description of the Related Art

A tri-axial bending load test measures rupture strength of a board material by putting the material on a die comprising a pair of support axes at a predetermined interval from each other, pressing a middle portion of the material by a punch and comparing a load at the point of the material being broken and the strength of a test piece.

Such a tri-axial bending load test is generally used in measuring the strength of a small-sized LCD panel of a mobile phone. FIGS. 1A and 1B schematically illustrate a method for measuring the strength of the LCD panel using a general tri-axial bending load testing jig.

As shown in FIGS. 1A and 1B, an LCD panel 1 is put on a pair of supporting axes 2 and 3 mounted in parallel at a predetermined interval on a die (not shown). A punch 4 is mounted on an upper center portion of the LCD panel 1 to move in a vertical direction.

As a predetermined load is applied on the LCD panel 1 by the punch 4, the LCD panel is deformed and finally broken. The strength of the LCD panel 1 is measured using the load at the point when the LCD panel 1 is broken.

When measuring the strength of the material using the tri-axial bending load testing jig, the measured result may vary according to a position of the LCD panel 1 or the punch 4. Therefore, the LCD panel 1 is required to be correctly placed on the supporting axes 2 and 3 of the die and at the same time, the punch 4 has to be placed exactly in the middle between and parallel with the two supporting axes 2 and 3 without any tilt.

However, since the interval between the two supporting axes 2 and 3 is constant in the conventional tri-axial bending load testing jig, LCD panels of diverse sizes cannot be adaptively and accurately measured.

Furthermore, in the conventional tri-axial bending load testing jig, a device for guiding the LCD panel 1 onto the supporting axes 2 and 3 is not dedicatedly provided. Therefore, it takes a long time to settle the LCD panel 1 to a correct position and set the center of the punch 4 and to set parallelism between the LCD panel 1 and the supporting axes 2 and 3. Consequently, this elongates the whole working time.

### SUMMARY OF THE INVENTION

An aspect of the present invention addresses at least the above problems and/or disadvantages and provides at least the advantages described below. Accordingly, an aspect of the present invention is to provide a tri-axial bending load testing jig capable of effectively measuring strength of a material having various sizes, such as a liquid crystal display (LCD) panel.

Another aspect of the present invention is to provide a tri-axial bending load testing jig capable of realizing accurate measurement and reduction of setting time and measuring time.

In order to achieve the above-described aspects of the present invention, there is provided a tri-axial bending load testing jig comprising a die including first and second supporting axes for upholding opposite sides of a board material; a punch mounted at an upper part of the die movable in a vertical direction to press down a center portion of the board material; and a punch setting unit formed in the center of the die to set the center and parallelism of the punch with respect to the first and the second supporting axes.

The punch setting unit has a punch groove formed in the center portion of the die parallel with the supporting axes to receive the punch.

The first and the second supporting axes are movable so that an interval therebetween can be adjusted according to a size of the board material, and respectively comprise a micrometer for accurately adjusting a shift of the first and the second supporting axes.

In an exemplary embodiment, the tri-axial bending load testing jig comprises a first scaled ruler formed on the die to check the shift of the first and the second supporting axes. The tri-axial bending load testing jig may comprise first and second micrometers which separately adjust the shift of the first and the second supporting axes.

In another exemplary embodiment, the tri-axial bending load testing jig comprises a material positioning unit which guides a seating position of the board material to be put on the first and the second supporting axes, according to the size of the board material.

The material positioning unit comprises a first and a second guide member which respectively move in directions of an X-axis and a Y-axis in contact with a side of the board material.

In an exemplary embodiment, the first and the second guide members are mounted at one of the first and the second supporting axes, and the one of the supporting axes mounting the guide members has a second scaled ruler for checking a shift of the first and the second guide members. The tri-axial bending load testing jig may comprise micrometers to accurately adjust the shift of the first and the second guide members.

In an exemplary embodiment, the punch comprises a supporting member; and a pressing member connected to the supporting member by a pin to adjust a tilt. Using the above-structured punch, occurrence of a tilt can be prevented when applying the load to the board material, thereby enabling more accurate measurement.

Consistent with another aspect of the present invention, a tri-axial bending load testing jig, comprises a die including a first and a second supporting axes which upholds opposite sides of a board material, the first and the second supporting axes movable so that an interval therebetween can be adjusted according to a size of the board material; a punch mounted at an upper part of the die movable in a vertical direction to press down a center portion of the board material and having a supporting member and a pressing member connected to the supporting member by a pin to adjust a tilt; a punch setting unit formed in the center of the die to set the center and parallelism of the punch with respect to the first and the second supporting axes and having a punch groove for receiving the punch at the center portion of the die; and a material positioning unit guiding a position of the board material to be put on the first and the second supporting axes, according to the size of the board material.

Consistent with yet another aspect of the present invention, there is provided a tri-axial bending load testing jig, comprising a die including first and second supporting axes for upholding opposite sides of a board material; a punch mounted at an upper part of the die movably in a vertical direction to press down a center portion of the board material; and a punch setting member provided to the first and the second supporting axes to set the center and parallelism of the punch with respect to the first and the second supporting axes and having a pair of supporting grooves for insertion of the first and the second supporting axes at a lower part thereof and a punch groove for receiving the punch at the upper center portion thereof and parallel with the supporting axes.

The first and the second supporting axes are movable so that an interval therebetween can be adjusted according to a size of the board material, and respectively comprise a micrometer for accurately adjusting a shift of the first and the second supporting axes.

The tri-axial bending load testing jig may comprise a first scaled ruler formed on the die to check the shift of the first and the second supporting axes. The tri-axial bending load testing jig may comprise first and second micrometers which separately adjust the shift of the first and the second supporting axes.

The tri-axial bending load testing jig may comprise a material positioning unit which guides a seating position of the board material to be put on the first and the second supporting axes, according to the size of the board material. The material positioning unit comprises a first and a second guide member which respectively move in directions of an X-axis and a Y-axis in contact with a side of the board material.

In an exemplary embodiment, the first and the second guide members are mounted at one of the first and the second supporting axes, and the one of the supporting axes mounting the guide members has a second scaled ruler for checking a shift of the first and the second guide members. The tri-axial bending load testing jig may comprise micrometers to accurately adjust the shift of the first and the second guide members.

### BRIEF DESCRIPTION OF THE DRAWING FIGURES

The above aspect and other features of the present invention will become more apparent by describing in detail exemplary embodiments thereof with reference to the attached drawing figures, wherein;

FIGS. 1A and 1B are views for illustrating a conventional tri-axial bending load testing jig and a method for measuring the strength of a liquid crystal display (LCD) using the same;

FIG. 2 is a front view of a tri-axial bending load testing jig consistent with an exemplary embodiment of the present invention;

FIG. 3 is a side view of FIG. 2;

FIG. 4 is a plan view of the tri-axial bending load testing jig of FIG. 2;

FIGS. 5A to 5D are views for explaining a method for corresponding centers of a punch and a die in the tri-axial bending load testing jig consistent with an exemplary embodiment of the present invention;

FIGS. 6A and 6B are views for explaining a method for adjusting an interval between supporting axes in the tri-axial bending load testing jig consistent with an exemplary embodiment of the present invention;

FIGS. 7A and 7B are views illustrating the tri-axial bending load testing jig guiding the setting of the LCD panel according to the size of the LCD panel, consistent with an exemplary embodiment of the present invention; and

FIG. 8 is a view illustrating the structure and a method for corresponding centers of a punch and a die in a tri-axial bending load test consistent with another exemplary embodiment of the present invention.

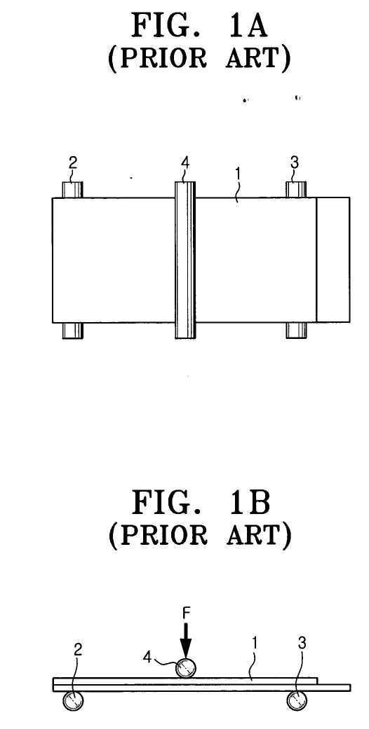

### DETAILED DESCRIPTION OF THE EXEMPLARY EMBODIMENTS

Hereinafter, certain embodiments of the present invention will be described in detail with reference to the accompanying figures.

In the following description, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail.

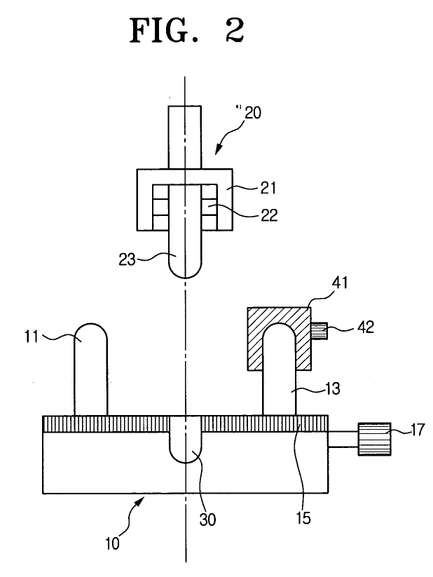

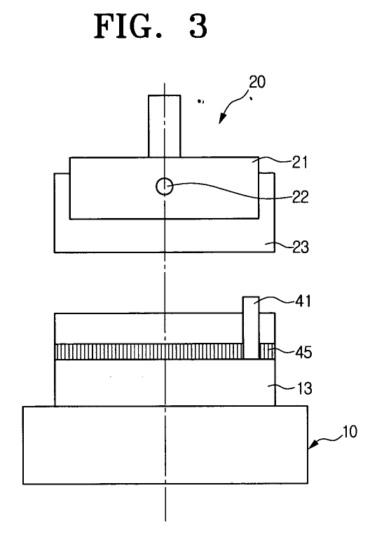

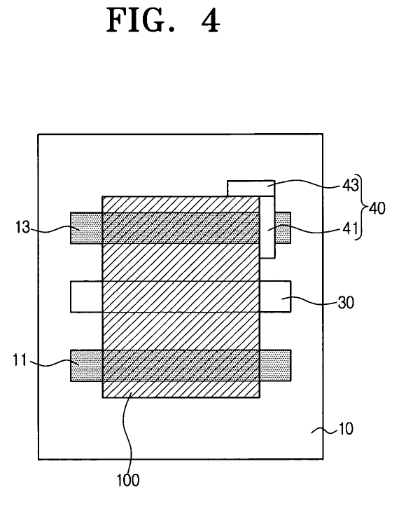

Referring to FIGS. 2 to 4, a tri-axial bending load testing jig consistent with an exemplary embodiment of the present invention, comprises a die 10, a punch 20 and a punch setting unit 30. An objective of the test in the drawings is a liquid crystal display (LCD) panel 100 as a board material.

The die 10 includes first and second supporting axes 11 and 13 for upholding opposite ends of the LCD panel 100 and mounted in parallel with each other. The first and the second supporting axes 11 and 13 are movably mounted on the die 10 so that the interval therebetween can be adaptively controlled according to the size of the LCD panel 100.

The first and the second supporting axes 11 and 13 may be configured to move simultaneously in opposite directions or independently. Although the former is more complicated to configure, it is more accurate and convenient in adjusting the interval between the supporting axes 11 and 13. On the contrary, the latter is relatively easy to configure in spite of inferior accuracy and convenience.

The die 10 comprises a first scaled ruler 15 for a user to easily view the first and the second supporting axes 11 and 13 being adjusted. As shown in FIG. 2, the first scaled ruler 15 is formed on a side of the die 10 by directly carving the scales into the die 10 or by attaching a general measuring tape.

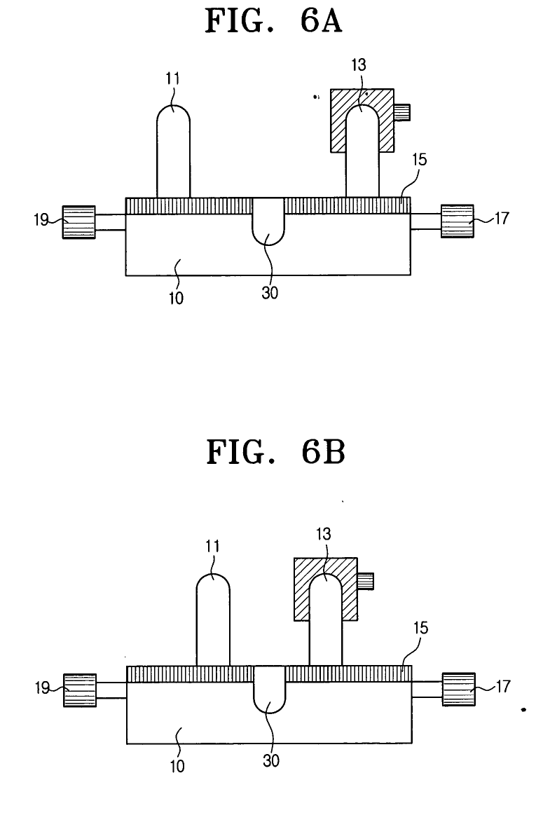

The die 10 usually comprises first and second micrometers 17 and 19 (FIGS. 6A and 6B) for accurately adjusting the positions of the first and the second supporting axes 11 and 13. As aforementioned, the first and the second supporting axes 11 and 13 can be simultaneously adjusted using a single micrometer 17.

The punch 20 is mounted on an upper part of the die 10 and movable in a vertical direction to press the middle portion of the LCD panel 100 placed on the first and the second supporting axes 11 and 13. Therefore, a predetermined load is applied onto the LCD panel 100, thereby deforming and finally breaking the LCD panel 100.

The punch 20 has the same length as the first and the second supporting axes 11 and 13. This may generate a tilt in a length direction of the punch 20, thereby causing unevenness of the load applied to the LCD panel 100 and deteriorating accuracy of the test.

In order to prevent generation of the tilt, the punch 20 comprises a supporting member 21 and a pressing member 23 movably connected to the supporting member 21 by a pin 22. No matter which position the pressing member 23 is in before contacting with the LCD panel 100, the pressing member 23 moves with respect to the pin 22 at the moment of contacting the LCD panel 100 and thereby applying load evenly onto the LCD panel 100. Accordingly, accuracy of the measurement can be improved.

The punch setting unit 30 helps set the center and parallelism of the punch 20 with respect to the first and the second supporting axes 11 and 13 correctly and conveniently. For this, the punch setting unit 30 includes a punch groove formed in the center of the die 10 parallel with the supporting axes 11 and 13.

The tri-axial bending load testing jig consistent with an exemplary embodiment of the present invention, further comprises a material positioning unit 40 which guides a seating position of the LCD panel 100 to be put on the supporting axes 11 and 13, according to the size of the LCD panel 100.

The material positioning unit 40 comprises first and second guide members 41 and 43 moving in directions of an X-axis and a Y-axis, respectively, in contact with a side of the LCD panel 100.

The first and the second guide members 41 and 43 are provided to one of the first and the second supporting axes 11 and 13. The one of the supporting axes 11 and 13 mounting the guide members 41 and 43 has a second scaled ruler 45 for measuring a shift of the first and the second guide member 41 and 43. As aforementioned regarding the first scaled ruler 15, the second scaled ruler 45 may be formed by carving directly into or attaching a general measuring tape onto the one of the supporting axes 11 and 13.

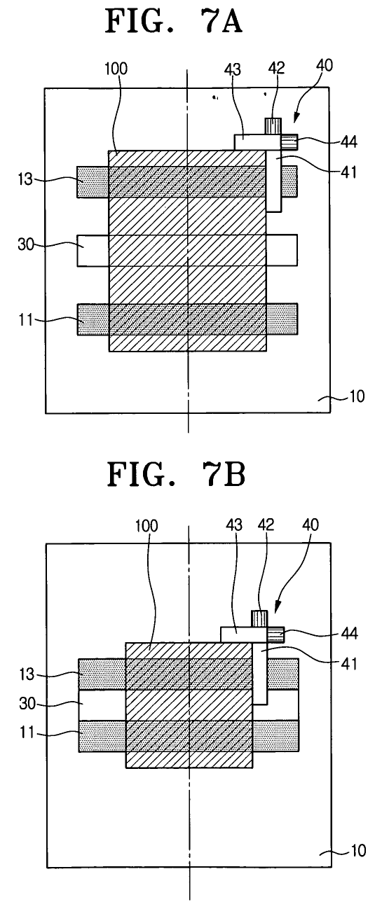

The material positioning unit 40 further comprises third and fourth micrometers 42 and 44 (FIG. 7A) to accurately adjust the shift of the first and the second guide members 41 and 43. Therefore, various sizes of the LCD panel 100 are applicable.

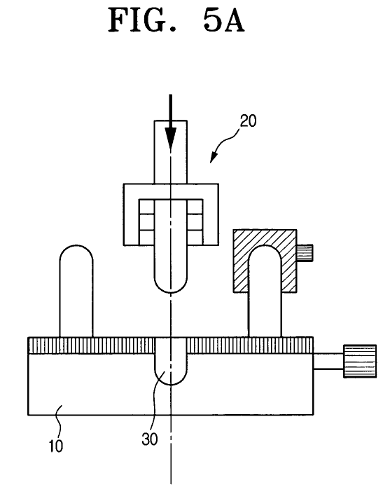

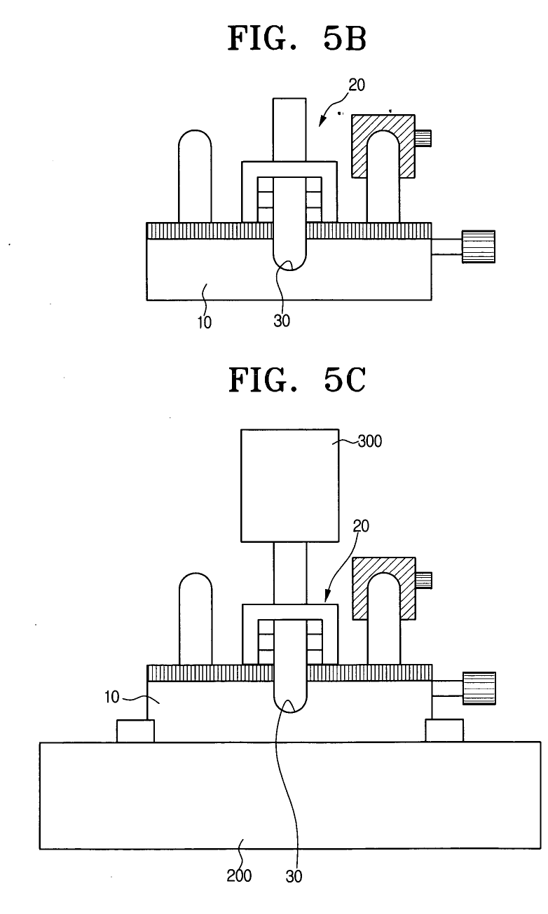

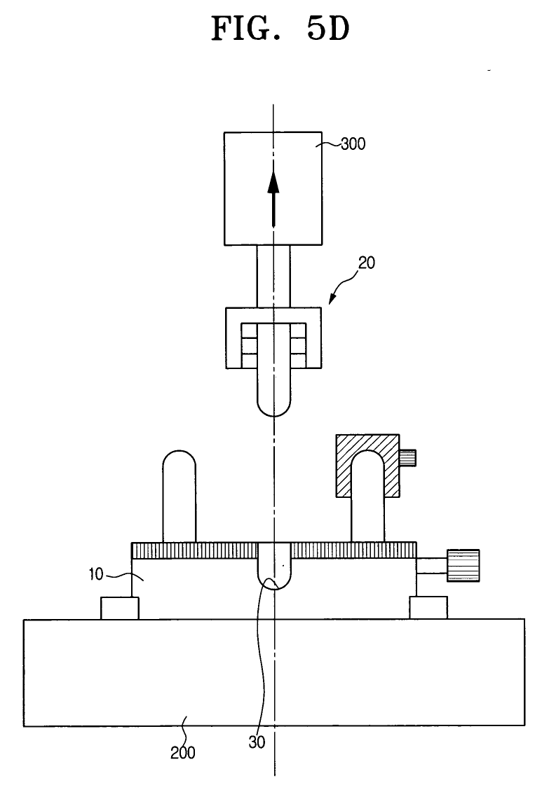

Hereinbelow, the characteristics and operation of the present invention will be described with reference to FIGS. 5 to 7.

FIGS. 5A to 5D illustrate the function and operation of corresponding central axes of the punch 20 and the die 10 in the tri-axial bending load testing jig consistent with an exemplary embodiment of the present invention.

As shown in FIG. 5A, the punch 20 is placed down before putting the material, that is, the LCD panel 100, on the die 10. As shown in FIG. 5B, the punch 20 is inserted to the punch groove of the punch setting unit 30 formed on the die 10. Here, since the groove of the punch setting unit 30 is formed exactly in the middle of the die 10 and parallel with the first and the second supporting axes 11 and 13, the punch 20 can be placed on the correct position.

As shown in FIG. 5C, a lower testing jig fixing plate 200 is fixed to the die 10 while an upper testing jig fixing shaft 300 is connected to the punch 20. As shown in FIG. 5D, the upper testing jig fixing shaft 300 stands by, being lifted to a test position.

FIGS. 6A and 6B illustrate the operation of adjusting the interval between the first and the second supporting axes 11 and 13 according to the size of the LCD panel 100.

When intending to narrow the interval from a state as shown in FIG. 6A to a state as shown in FIG. 6B or vice versa, the first and the second micrometers 17 and 19 are rotated clockwise or counterclockwise. According to the rotation of the first and the second micrometers 17 and 19, the first and the second supporting axes 11 and 13 are moved forward or backward, thereby coming close to or being distanced from each other. The interval between the supporting axes 11 and 13 can be accurately adjusted using the first scale ruler 15.

FIGS. 7A and 7B illustrate the operation of guiding the position of the LCD panel 100 onto the supporting axes 11 and 13, according to the size of the LCD panel 100. Regardless of the size of the LCD panel 100, the first and the second guide member 41 and 43 can support one side of the LCD panel 100, respectively, as an L-shape. Therefore, the position of the LCD panel 100 can be correctly set. The shift of the first and the second guide members 41 and 43 according to the size of the LCD panel 100 can be accurately adjusted through the third and the fourth micrometers 42 and 44 and the second scaled ruler 45.

With the central axes of the punch 20 and the die 10 exactly aligned with each other, with the interval between the supporting axes 11 and 13 adjusted according to the size of the LCD panel 100, and with the LCD panel 100 set on the right position as described above, the punch 20 is moved down to apply a predetermined load on the LCD panel 100. A load at the moment the LCD panel 100 is broken is measured and compared with a reference load value. Thus, whether the strength of the LCD panel 100 is within a standard range of strength is determined and fed back to a production line.

As described above, consistent with an exemplary embodiment of the present invention, the punch 20 and the material can be conveniently and correctly set regardless of the size of the material. Therefore, accuracy of the measurement can be enhanced compared to a case of using a conventional tri-axial bending load testing jig.

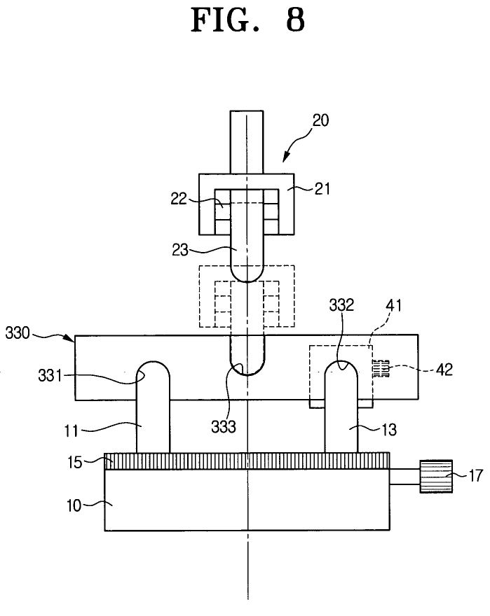

FIG. 8 is a view schematically showing a tri-axial bending load testing jig consistent with another exemplary embodiment of the present invention. In this embodiment, a punch setting member 330 is dedicatedly provided on the die 10 when setting the position of the punch 20, instead of the punch setting unit 30 comprising the groove. The other structures are all the same as in the previous embodiment.

The punch setting member 330 comprises a pair of supporting grooves 331 and 332 for insertion of the first and the second supporting axes 11 and 13 at a lower part thereof, and a punch groove 333 for receiving the punch 20 at an upper center portion thereof.

In the similar manner as the previous embodiment, the punch setting member 330 is mounted to the first and the second supporting axes 11 and 13 of the die 10, and the punch 20 is moved down to be received in the punch receiving groove 333 of the punch setting member 330, thereby setting the center and parallelism of the punch 20 and the die 10. Since the other structures and the operation are the same as in the previous embodiment, a detailed description thereof will be omitted.

As can be appreciated from the above description, a material of various sizes can be adaptively and conveniently set on a correct position for measurement. Accordingly, errors in the measurement can be prevented from occurring, also saving the amount of measurement time.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A tri-axial bending load testing jig comprising:
a die comprising first and second supporting axes operable to uphold opposite sides of a board material;
a punch mounted at an upper part of the die movable in a vertical direction to press down a center portion of the board material; and
a punch setting unit formed in the center of the die to set the center and parallelism of the punch with respect to the first and the second supporting axes.

2. The tri-axial bending load testing jig of claim 1, wherein the punch setting unit has a punch groove formed in the center portion of the die parallel with the first and the second supporting axes to receive the punch.

3. The tri-axial bending load testing jig of claim 1, wherein the first and the second supporting axes are movable so that an interval between the first and the second supporting axes can be adjusted according to a size of the board material.

4. The tri-axial bending load testing jig of claim 3, further comprising a first scaled ruler formed on the die to check a shift of the first and the second supporting axes.

5. The tri-axial bending load testing jig of claim 4, further comprising a first and a second micrometer which separately adjusts the shift of the first and the second supporting axes respectively.

6. The tri-axial bending load testing jig of claim 1, further comprising a material positioning unit which guides a seating position of the board material to be put on the first and the second supporting axes, according to the size of the board material.

7. The tri-axial bending load testing jig of claim 6, wherein the material positioning unit comprises a first and a second guide member which respectively move in directions of an X-axis and a Y-axis in contact with a side of the board material.

8. The tri-axial bending load testing jig of claim 7, wherein the first and the second guide members are mounted at one of the first and the second supporting axes, and the one of the supporting axes mounting the guide members has a second scaled ruler for checking a shift of the first and the second guide members.

9. The tri-axial bending load testing jig of claim 8, further comprising a third and a fourth micrometer to accurately adjust the shift of the first and the second guide members.

10. The tri-axial bending load testing jig of claim 1, wherein the punch comprises:
a supporting member; and
a pressing member connected to the supporting member by a pin to adjust a tilt.

11. A tri-axial bending load testing jig, comprising:
a die comprising a first and a second supporting axes which upholds opposite sides of a board material, the first and the second supporting axes are movable so that an interval therebetween can be adjusted according to a size of the board material;
a punch mounted at an upper part of the die movable in a vertical direction to press down a center portion of the board material and having a supporting member and a pressing member connected to the supporting member by a pin to adjust a tilt;
a punch setting unit formed in the center of the die to set the center and parallelism of the punch with respect to the first and the second supporting axes and having a punch groove for receiving the punch at the center portion of the die; and
a material positioning unit guiding a position of the board material to be put on the first and the second supporting axes, according to the size of the board material.

12. A tri-axial bending load testing jig, comprising:
a die comprising a first and a second supporting axes for upholding opposite sides of a board material;
a punch mounted at an upper part of the die movable in a vertical direction to press down a center portion of the board material; and
a punch setting member provided on the first and the second supporting axes to set the center and parallelism of the punch with respect to the first and the second supporting axes and having a pair of supporting grooves for insertion of the first and the second supporting axes at a lower part thereof and a punch groove for receiving the punch at the upper center portion thereof and parallel with the supporting axes.

13. The tri-axial bending load testing jig of claim 12, wherein the first and the second supporting axes are movable so that an interval between the first and the second supporting axes can be adjusted according to a size of the board material.

14. The tri-axial bending load testing jig of claim 13, further comprising a first scaled ruler formed on the die to check a shift of the first and the second supporting axes.

15. The tri-axial bending load testing jig of claim 14, further comprising a first and a second micrometer which separately adjusts the shift of the first and the second supporting axes respectively.

16. The tri-axial bending load testing jig of claim 12, further comprising a material positioning unit which guides a seating position of the board material to be put on the first and the second supporting axes, according to the size of the board material.

17. The tri-axial bending load testing jig of claim 16, wherein the material positioning unit comprises a first and a second guide member which respectively move in directions of an X-axis and a Y-axis in contact with a side of the board material.

18. The tri-axial bending load testing jig of claim 17, wherein the first and the second guide members are mounted at one of the first and the second supporting axes, and the one of the supporting axes mounting the guide members has a second scaled ruler for checking a shift of the first and the second guide members.

19. The tri-axial bending load testing jig of claim 18, comprising a third and a fourth micrometer to accurately adjust the shift of the first and the second guide members.

20. The tri-axial bending load testing jig of claim 12, wherein the punch comprises:
a supporting member; and
a pressing member connected to the supporting member by a pin to adjust a tilt.
